(19) United States
(12) Patent Application Publication
(10) Pub. No.: US 2010/0228740 A1
(43) Pub. Date: Sep. 9, 2010

(54) COMMUNITY PLAYLIST MANAGEMENT

(75) Inventors: Alan CANNISTRARO, San Francisco, CA (US); William Martin Bachman, San Jose, CA (US); Jeffrey L. Robbin, Los Altos, CA (US); Amandeep Jawa, San Francisco, CA (US); Rainer Brodersen, San Jose, CA (US); Gregory Charles Lindley, Sunnyvale, CA (US)

Correspondence Address: Apple Inc., 1000 Louisiana Street, Fifty-Third Floor, Houston, TX, 77002, US

(73) Assignee: Apple Inc., Cupertino, CA (US)

(21) Appl. No.: 12/400,743

(22) Filed: Mar. 9, 2009

(51) Int. Cl. G06F 7/00; G06F 17/30; G06Q 99/00; G06F 3/048

(52) U.S. Cl. 707/748; 715/700; 707/E17.009; 707/E17.101; 705/319; 705/12

(57) ABSTRACT

System and method in tangible computer-readable media are disclosed for facilitating community interaction with a playlist. A host system communicates with a plurality of portable devices to transmit information about the items in the playlist. Users of the portable device queue additional selections or vote on media items in the playlist. Based on user voting the playlist is rearranged to accommodate the preferences of the community. Both registered and guest users participate in managing the playlist. Such a system and method can be particularly useful in a variety of social gathering situations.

### TECHNICAL FIELD

The present disclosure relates to a method and system for allowing a plurality of users to interact with a playlist and specifically for allowing listeners to vote on items within the playlist using their mobile telephones and based on the votes, the playlist can be reordered.

### INTRODUCTION

Increasingly media is bought, dispersed, enjoyed and manipulated in digital formats and following this shift, playlists for enjoying the media are also increasingly popular. The use of digital media, especially compressed digital media, has made it possible for users and machines to create playlists easily.

People often use their media playing devices to automatically add music to a queue. In some cases this automatic selection is random, and in other instances algorithms produce more sophisticated playlists that are better suited a user's tastes. Some of the sophisticated playlist algorithms, can for example, take into account the similarity of songs based on their musical characteristics, or based on the feedback of the population at large, or based of the tastes in music of just one user. In some cases, these playlists can generate a great playlist, but in other situations the playlist might be lacking.

Good playlists are especially tough to create when the playlist is made for a group of people at a social gathering. The playlist algorithms have no method of understanding the mood of the listener(s) or the tastes of the population. A subset of the population frequently doesn't have the same tastes in music or movies as the population at large so even playlist that rely on this data would benefit from knowing the tastes of the specific people “enjoying” the playlist. Accordingly, there is a need to be able incorporate the influence of those listening population into the playlist to truly optimize the playlist.

Examples of potential situations where a need exists for a population to exert influence on a playlist include at bars, pubs, restaurants, parties, or social gatherings in general. In each situation, media, such as music, can really enhance the atmosphere of any social event. Whether a jukebox fails to play any songs that a group of patrons enjoy, or a friend at a party cannot put a decent playlist together, these are just a few of the examples when the influence of the local population that is actually listening to the music can make a big improvement. Accordingly, the present disclosure addresses the deficiencies in the art as set forth above.

### SUMMARY

Additional features and advantages of the concepts disclosed herein are set forth in the description which follows, and in part will be obvious from the description, or may be learned by practice of the described technologies. The features and advantages of the concepts may be realized and obtained by means of the instruments and combinations particularly pointed out in the appended claims. These and other features of the described technologies will become more fully apparent from the following description and appended claims, or may be learned by the practice of the disclosed concepts as set forth herein.

The present disclosure describes methods and arrangements for facilitating community ranking of items in a playlist as well as host devices and tangible computer-readable media for directing the operations of a host device for performing the same functions. A playlist host device transmits information to a plurality of user devices such as metadata related to media items in a playlist. The metadata includes the order of the playlist, community ranking information, song title, and artist name among other items. The user devices send, and the host device receives, votes related to a media item. The votes can be positive or negative and based on these votes the host device can reorganize the playlist to take into account the preferences of the community, such as a collection of people at a party, restaurant, bar or any other gathering of people. In some embodiments, portions of the playlist include a vote-independent region and a vote-dependent region wherein the host device reorganizes the vote-dependent region based on received votes.

Songs are added to the playlist in conventional fashion such as by selecting media items from a media library using a graphical user interface on the host device. Permission can be given to allow authorized users or guests to queue songs remotely from their user devices. Requested songs can be treated as positive votes. Songs can also be automatically added to the playlist by a program on the host device for that purpose. Songs added by a program can be treated differently than those that are requested by users, for example, by adding program requested songs to the bottom of the playlist and adding user requested songs to the playlist in a higher position. In some embodiments the playlist has at least one set portion, which is not susceptible to adjusting the positions of the media items in this portion and at least one adjustable portion, which is susceptible to adjusting the positions of the media items in this portion.

Also described is a processor-implemented method for facilitating community interaction with a playlist on a host device, wherein the host device sends a playlist on a host device to a plurality of portable devices for display on a graphical user interface, and the host device receives from at least one portable device a positive or a negative vote for a media item in the playlist. Based on the received votes, the media item's position in the playlist is adjusted such as by promoting songs with positive votes and demoting songs with negative votes. Songs with enough negative votes can be removed from the playlist.

In some embodiments, the portable devices connect to and communicate with the electronic device over a local area network, which can be utilized by guests at a social gathering, but communications are not limited to this medium. Examples of potential electronic devices include, but are not limited to jukeboxes, home radios, karaoke machines, and personal computers.

### BRIEF DESCRIPTION OF THE DRAWINGS

In order to best describe the manner in which the above-described embodiments are implemented, as well as define other advantages and features of the disclosure, a more particular description is provided below and is illustrated in the appended drawings. Understanding that these drawings depict only exemplary embodiments of the invention and are not therefore to be considered to be limiting in scope, the examples will be described and explained with additional specificity and detail through the use of the accompanying drawings in which:

FIG. 1 illustrates an example computing device;

FIG. 2 illustrates an example system embodiment;

FIG. 3 illustrates a method embodiment for connecting a portable computing device to a host;

FIG. 4 illustrates a method embodiment for connecting a host with a portable computing device;

FIG. 5 illustrates a graphical user interface embodiment;

FIG. 6 illustrates a graphical user interface embodiment;

FIG. 7 illustrates a graphical user interface embodiment;

FIG. 8 illustrates a graphical user interface embodiment;

FIG. 9 illustrates a method embodiment of adding a media item to a playlist; and

FIG. 10 illustrates a playlist embodiment.

### DETAILED DESCRIPTION

Various embodiments of the disclosed methods and arrangements are discussed in detail below. While specific implementations are discussed, it should be understood that this is done for illustration purposes only. A person skilled in the relevant art will recognize that other components, configurations, and steps may be used without parting from the spirit and scope of the disclosure.

One method for using a portable media player to interact with the host device is described in U.S. application Ser. No. 11/314,291 entitled “Portable Media Player As A Low Power Remote Control” and invented by Ko et al. which is assigned to Apple Computer Inc. of Cupertino, Calif. and is herein incorporated by reference in its entirety. This disclosure next introduces general details about possible device embodiments.

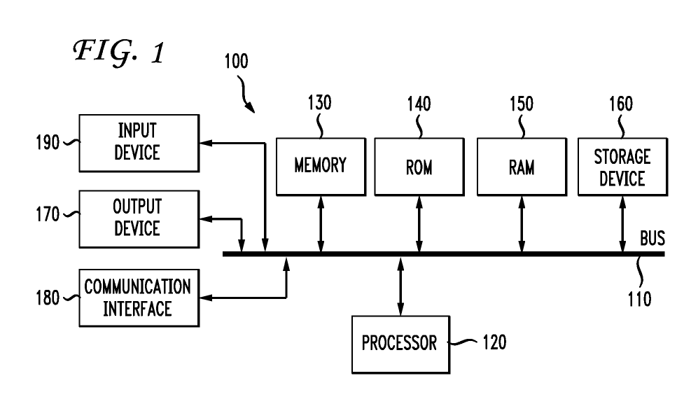

With reference to FIG. 1, a general-purpose device 100 which can be portable or stationary is shown, including a processing unit (CPU) 120 and a system bus 110 that couples various system components including the system memory such as read only memory (ROM) 140 and random access memory (RAM) 150 to the processing unit 120, the device 100 may be a computing device. Other system memory 130 may be available for use as well. It can be appreciated that the system may operate on a computing device with more than one CPU 120 or on a group or cluster of computing devices networked together to provide greater processing capability. The system bus 110 may be any of several types of bus structures including a memory bus or memory controller, a peripheral bus, and a local bus using any of a variety of bus architectures. A basic input/output (BIOS) stored in ROM 140 or the like, may provide the basic routine that helps to transfer information between elements within the device 100, such as during start-up. The device 100 further includes storage devices such as a hard disk drive 160, a magnetic disk drive, an optical disk drive, tape drive or the like. The storage device 160 is connected to the system bus 110 by a drive interface. The drives and the associated computer readable media provide nonvolatile storage of computer readable instructions, data structures, program modules and other data for the computing device 100. In one aspect, a hardware module that performs a particular function includes the software component stored in a tangible computer-readable medium in connection with the necessary hardware components, such as the CPU, bus, display, and so forth, to carry out the function. The basic components are known to those of skill in the art and appropriate variations are contemplated depending on the type of device, such as whether the device is a small, handheld computing device, a desktop computer, or a large computer server.

Although the exemplary environment described herein employs a hard disk or other memory such as memory from Fusion-io, it should be appreciated by those skilled in the art that other types of computer readable media which can store data that is accessible by a computer, such as magnetic cassettes, flash memory cards, digital versatile disks, cartridges, random access memories (RAMs), read only memory (ROM), a cable or wireless signal containing a bit stream and the like, may also be used in the exemplary operating environment.

To enable user interaction with the computing device 100, an input device 190 represents any number of input mechanisms, such as a microphone for speech, a touch-sensitive screen for gesture or graphical input, keyboard, mouse, motion input, speech and so forth. The input may be used by the presenter to indicate the beginning of a speech search query. The device output 170 can also be one or more of a number of output mechanisms known to those of skill in the art. For example, video output or audio output devices which can be connected to or can include displays or speakers are common. Additionally, the video output and audio output devices can also include specialized processors for enhanced performance of these specialized functions. In some instances, multimodal systems enable a user to provide multiple types of input to communicate with the computing device 100. The communications interface 180 generally governs and manages the user input and system output. There is no restriction on the disclosed methods and devices operating on any particular hardware arrangement and therefore the basic features may easily be substituted for improved hardware or firmware arrangements as they are developed.

For clarity of explanation, the illustrative system embodiment is presented as comprising individual functional blocks (including functional blocks labeled as a “processor”). The functions these blocks represent may be provided through the use of either shared or dedicated hardware, including, but not limited to, hardware capable of executing software. For example the functions of one or more processors presented in FIG. 1 may be provided by a single shared processor or multiple processors. (Use of the term “processor” should not be construed to refer exclusively to hardware capable of executing software.) Illustrative embodiments may comprise microprocessor and/or digital signal processor (DSP) hardware, read-only memory (ROM) for storing software performing the operations discussed below, and random access memory (RAM) for storing results. Very large scale integration (VLSI) hardware embodiments, as well as custom VLSI circuitry in combination with a general purpose DSP circuit, may also be provided.

The logical operations of the various embodiments are implemented as: (1) a sequence of computer implemented steps, operations, or procedures running on a programmable circuit within a general use computer, (2) a sequence of computer implemented steps, operations, or procedures running on a specific-use programmable circuit; and/or (3) interconnected machine modules or program engines within the programmable circuits.

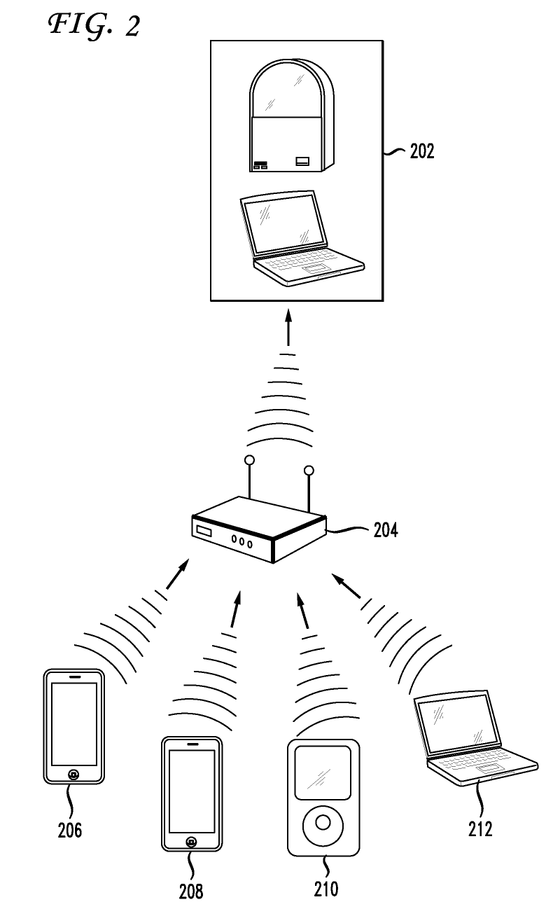

The present system and method is particularly useful for group collaboration in making and managing playlists and is generally illustrated in FIG. 2. A playlist is hosted by host device 202 hosts a playlist, which can be any device suitable for use in the system. As depicted here, the device can be a jukebox or a personal computer, but the illustration should not be considered as limiting the possible host devices. A community of users can interact with the host device 202 via their portable device 206, 208, 210, 212 via any suitable electronic communications medium well known by those in the art. The portable devices can be a mobile phone 206, portable media playing device 208, 210 a computer 212 or any other device capable of electronic communication with the host device.

Through use of their portable device 206, 208, 210, 212 users interact with the playlist to request new songs, submit votes of for or against a song, move songs up or down the playlist, skip songs, repeat songs, or otherwise remotely interact with the playlist in any way that they would while interacting directly with the host device. Additionally, many users interact with the playlist at once. For example, users of devices 206, 208, 210, and 212 all interact with the playlist to generate a community driven playlist. Votes that are cast are tallied and affect the order of the playlist or the songs that will be played. In such a way, the described system allows community input into the playlist.

Devices 206, 208, 210, and 212 communicate with the host device using any convenient electronic communications medium; however wireless communications are depicted in FIG. 2. In this example, the portable devices 206, 208, 210, and 212 are wirelessly connected to a network device 204 which is also connected via an electronic communications medium to host device 202, again depicted as a wireless connection. While in the preferred embodiment the devices communicate using any of the 802.11 series of communication protocols, any wired or wireless communications medium is acceptable including using a cellular telephone network or wired networks.

The network device 204 can support a wireless network. The wireless network can take the form of, for example, a “WiFi” interface according to the IEEE 802.11 series of standards. Other wireless network standards could also be used, either in alternative to the identified standards or in addition to the identified standards. Such other network standards could include the Bluetooth standard.

The network device 204 can send and receive wireless network signals that can be received by the host device 202 and portable devices 206, 208, 210, and 212, which are equipped with antennas configured to receive and transmit wireless signals. Such antennas may take a variety of forms, such as antennas printed on a standard printed circuit board and are well known to those skilled in the art.

In other embodiments the network device 204 may not be necessary. For example, in the case of the Bluetooth standard, direct communication between the portable electronic device(s) and the host device is enabled. Again all devices are equipped with an antennae configured to send and receive wireless signals.

Regardless of which communications medium is employed, whether wired or wireless, a communication interface is used to send and receive electronic communications signals, demodulate the data sent in the form of packets or cells and translate the data into a format usable by the processing device or translate the data received from the processor over a bus and modulate the data into the appropriate format for the chosen communications medium.

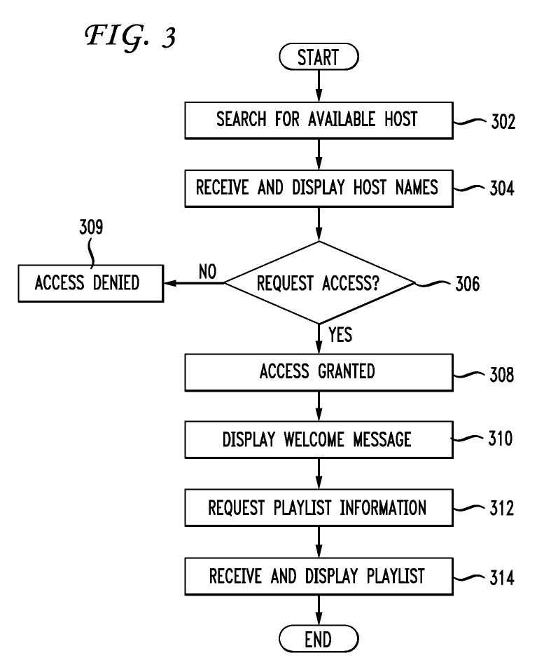

As described above, users interact with the host device using a portable device or device. FIG. 3 shows an example method for gaining access to the host device. In step 302 the portable device searches for an available host and displays received host names at step 304. In order to maintain the security and privacy of potential hosts, host names are displayed only when the host has been configured to do so. After the host names are displayed on a user's portable device, the user can select a host and request access in step 306. Before granting access the host can prompt the device for a password or request some other credential by any conventional means well known to those of skill in the art before allowing the portable device to have access to the host. In step 309 access can be denied or in step 308 access is granted.

After access is granted, the portable device displays a welcome message received from the host device, as illustrated in step 310. The welcome message explains how to use the system, confirms to the user that they joined the desired host device or displays any other relevant information. Next the portable device requests playlist information at step 312 and receives and displays the information at 314. The playlist information includes any useful information regarding the playlist including, for example media items and various meta data, but in some embodiments, information such as previously played items, currently playing item, queue items, item name, artist, album, genre, and ratings are contemplated.

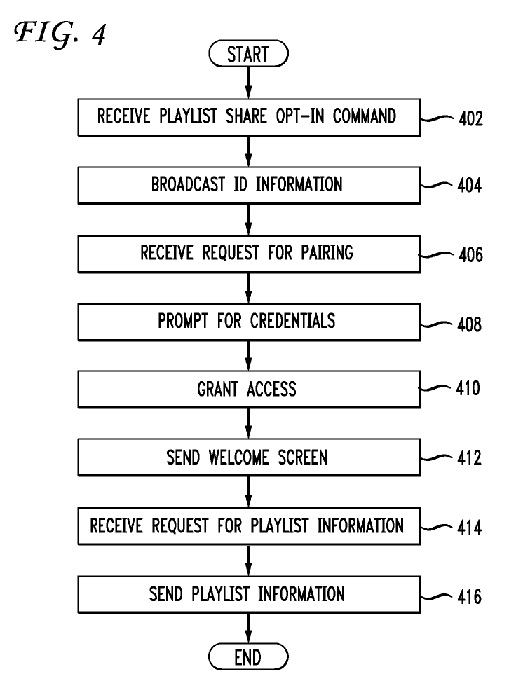

FIG. 4 illustrates the pairing of the portable device with the host from the host's perspective. At step 402 the host receives an opt-in command from an authorized user. The opt-in command instructs the host to allow remote access to the playlist. Access may be tiered, as will be discussed in greater detail below, to allow limited functionality to unregistered guests and full access to an authorized, registered user. Step 402 also instructs the host to take appropriate steps to make itself available for pairing with portable devices. For example at step 404 the host broadcasts identifying information so that the portable devices can find the host. One method of broadcasting the host's identification information is to use a multicast or broadcast service to announce the presence of the device such as a service discovery protocol. One well-known example of a service discovery protocol is BONJOUR by Apple Inc., Cupertino, Calif., which is a technology that enables automatic discovery of computers, devices, and services on IP networks.

Communications between the portable device and the host device over a network is initiated through a discovery protocol such as BONJOUR. Also known as Zero Configuration Networking, BONJOUR uses standard IP protocols to allow devices to automatically find each other without the need for a user to enter IP addresses or configure DNS servers. Implementation details may be found in the following patent applications, which are hereby incorporated by reference in their entirety: (1) “Method and Apparatus for Configuring a Wireless Device Through Reverse Advertising,” application Ser. No. 10/102,321, filed Mar. 19, 2002; (2) “Method and Apparatus for Supporting Duplicate Suppression When Issuing Multicast DNS Queries Using DNS_Format Message Packets,” application Ser. No. 10/102,174, filed Mar. 19, 2002; and (3) “Method and Apparatus for Implemented a Sleep Proxy for Services on a Network,” application Ser. No. 60/496,842, filed Aug. 20, 2003.

The discovery protocol can facilitate communications between two devices on a network by identifying the devices to each other. In the case of a host device, it can advertise over a network using multicast or broadcast that it supports playlist hosting and any other service such as perhaps audio streaming to other devices on the network. In addition to the availability of the service, the device can publish the name of the device providing the service, the network address of the device, and one or more configuration parameters that are related to the service. The registration of the service can also include security, encryption, compression, and other capabilities and/or parameters that are necessary for communicating with the device.

The portable communications device can listen for incoming configuration packets, and create a service advertisement announcing the fact that it is listening and ready for configuration. This announcement can be made using DNS Service Discovery, or any other Service Discovery protocol known to those skilled in the art.

After the portable device has located the host device, it will request and the host device will receive the request for pairing in step 406. The host device can in turn request credentials from the portable device at step 408. If the credentials are accepted, the host device can grant access at step 410 and send a welcome screen at step 412. More than one personal device can be paired with the host.

Once pairing is complete, the host device can receive a request from the portable device for playlist information at step 414 and deliver the playlist information at step 416. Steps 414 and 416 can be continually repeated to update the playlist information on the portable device.

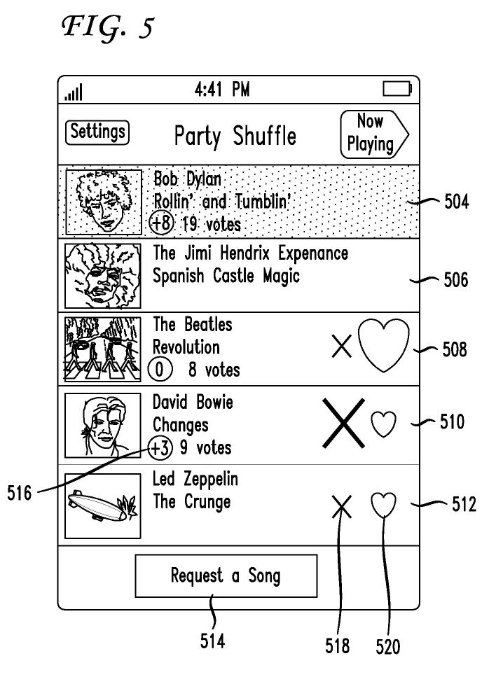

Now that the portable device and the host are paired, the portable device can be used to remotely manage the playlist. FIG. 5 illustrates a sample user interface for a portable device. In this view the device highlights the currently playing selection 504. Below selection 504, the device displays queued songs 506-512. Each selection is also displayed along with selected metadata attributes such as song name, artist, and album artwork, but such attributes should not be considered as limiting; any variation of additional data regarding the selections is contemplated in the present technology. While not shown in this figure, a user of the portable device can access additional songs in the playlist by manipulating the device. As shown, a touch screen interface allows manipulation by sweeping gestures across the screen. A downward sweeping gesture reveals songs previously played while an upward sweeping gesture reveals additional queued songs. It will be appreciated, however, that the technology herein described is not limited to use on only touchscreen devices. Any existing portable device interface can used to achieve the same purposes.

Associated with the queued items 508-512 are icons 518 and 520 that allow users of the paired portable devices to vote a song up 520 or down 518. Presumably votes are cast as an indication of preference. For every positive vote cast by selecting icon 520, the song's voting score 516 is raised one integer; for every negative vote 518, the song's voting score 516 is lowered one integer. While for purposes of this example, votes are counted as integer adjustments, any adjustment that allows a voting algorithm to keep track of the relative popularity of song based on votes received from the paired portable devices can be used.

The order of the queued songs 506, 508, 510, 512 can be affected by each song's voting score 516, although in FIG. 5, queue selection 506 illustrates an embodiment wherein it is no longer available for voting. Presumably votes are cast as an indication of preference. Songs receiving positive votes and thus having increased voting scores can be advanced in the queue so that more popular songs will play earlier than less popular songs. Likewise, songs receiving negative votes can have reduced voting scores and can be demoted in the playlist. It is also possible that songs can be voted off the list if they achieve a poor enough voting score. In this figure, the user of this portable device has voted on song 510 negatively, voted on song 508 positively and has not voted on song 512. The enlarged icons indicate the past votes. As discussed above the list can be rearranged in response to votes. Song 508, is queued to play before song 510 because it has a higher voting score 516. Users of the portable device may get one vote so that they cannot unfairly overrun the list. Even though these remote users get only one vote, they can change their vote.

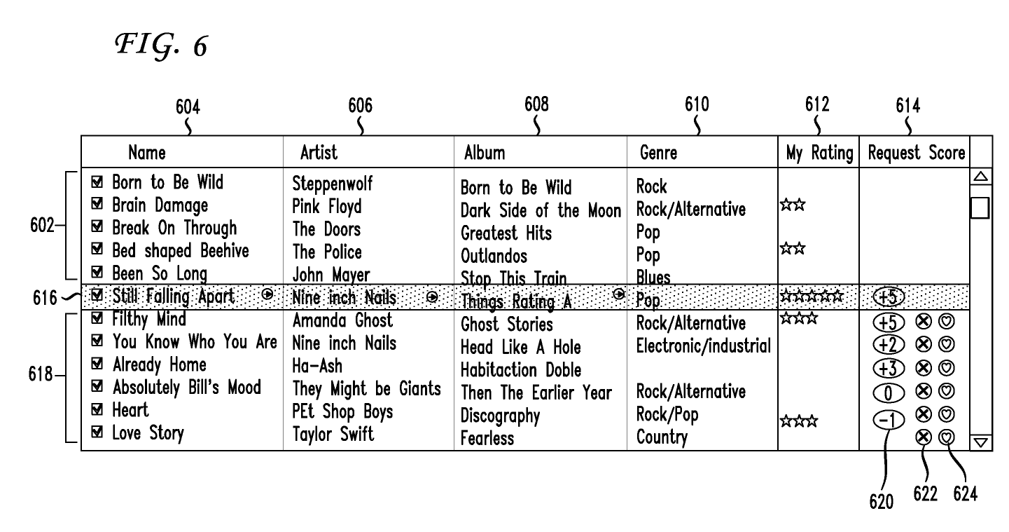

FIG. 6 illustrates a sample playlist on the host device. In addition to the recently played songs 602, currently playing song 616, the queued songs 618 and associated metadata 604, 606, 608, 610 and 612, a request score 614 is also displayed. Different from the request score 614 that displays the communities rating of the song, the rating 612, displays the owner's rating of the song.

Associated with the queue items 618 are icons 622 and 624 that allow the user of the host device to vote a song up 624 or down 622 directly at the host. For every positive vote 624, the song's voting score 620 is raised one integer; for every negative vote 622, the song's voting score 620 is lowered one integer. While for purposes of this example, votes are counted as integer adjustments, any adjustment that allows a voting algorithm to keep track of the relative popularity of song based on votes received from the paired portable devices can be used.

The order of the queued songs 618 is affected by each songs voting score 620, which again, represents the total score based on input from any paired portable device that has sent a vote to the host and any votes cast directly with the host. Songs receiving positive votes and thus having increased voting scores are advance in the queue so that more popular songs will play earlier than less popular songs. Likewise, songs receiving negative votes can have reduced voting scores and are demoted in the playlist. It is also possible that songs can be voted off the list if they achieve a poor enough voting score.

In addition to voting, the order of a playlist can also be modified by adding new songs to the playlist. Songs can be added at the host according to any well-known method in the art. Many media managing software applications exist for both personal computers and jukebox type devices and these applications can be used to manage the playlist or to allow new songs to be added to the playlist directly at the host.

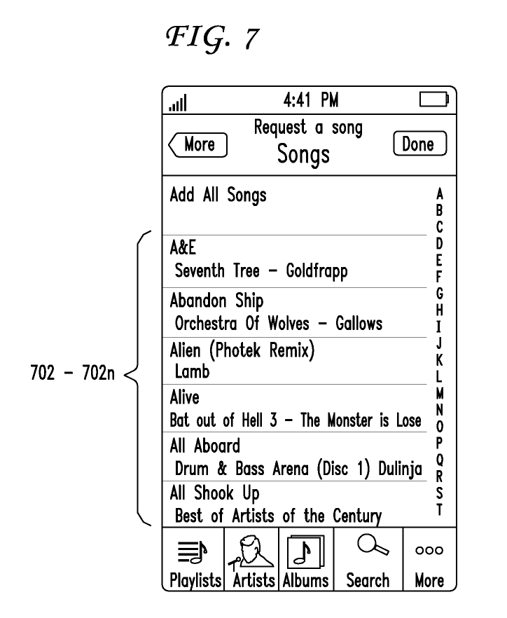

Songs can also be added to the playlist remotely. Referring again to FIG. 5, a user may request a song to be added to the playlist by selecting button 514 on the portable device. Selecting button 514 results in the portable device making a request of the host for library information, which can be displayed on the screen illustrated in FIG. 7 showing candidate songs 702-702n. When a song is selected a details screen can be displayed or the song can be immediately added to the playlist.

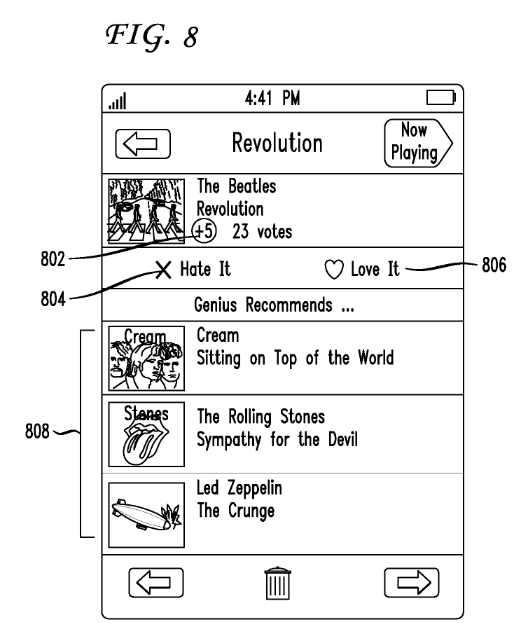

Whether a song is selected from the host's library or a song is selected in the playlist, a details screen can be viewed for that selection as seen in FIG. 8. In this screen, the user has selected The Beatles' song Revolution and the interface presents buttons 804 and 806 to allow the user to cast a vote for the song. Alternatively, buttons could be provided to allow the user to add the song to the playlist if it isn't already represented. The voting score 802 is also displayed. Additionally, the system can also recommend other songs 808 to be added to the playlist.

Song recommendations can be made via any number of methods now known in the art. In some embodiments the song recommendations can come from the portable device itself, or from the host, or even from a remote server. The user can also select a recommended song to be added to the playlist.

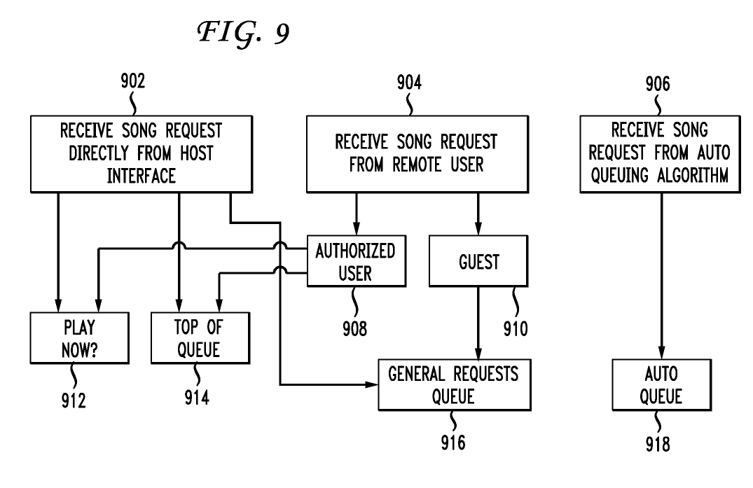

Songs can be added to the playlist in at least three different ways. As illustrated in FIG. 9, songs can be queued directly from the host device's user interface as seen in step 902 or queued by remote users in step 904 or queued automatically by an auto-queuing algorithm 906. Depending on where the added song request comes from, the song can be treated differently. For example, if the song is requested from the host device interface itself, the user can be given extra options such as to play the song immediately 912 or to put the song as next in the queue 914 or to place the song in the general requests queue 916. This option can be especially useful when the host device is a personal computer and it can be assumed that only the owner is interacting directly with the host device and thus that user is given additional permissions. Compare this scenario with the scenario in 904 wherein the song request is coming from a remote user. In this instance the system can assume that the user is a guest 910 to the system and they only have permission to add their requests to the general request queue 916. Alternatively, the system can distinguish between authorized remote users 908 and guest remote users 910. In this example, the authorized user can have the same permissions as if they were interacting directly with the host interface and can therefore force a song to play immediately 912, play next 914, or be added to the general queue 916. If the song request comes from a guest user as determined at step 910, the song request can only be added to the general requests queue 916.

Songs being queued automatically 906 by an algorithm or process running on the host device can also be distinguished and put into the auto queue 918. This can allow the system to give priority to all songs requested by users over songs automatically queued.

Not only can songs be placed into different portions of the queue based on who requested them or how they were requested, but the songs can be treated differently as well. For example, songs added by users might be immune to removal from the playlist since at least one person requested the song while songs auto-queued can be voted off the playlist.

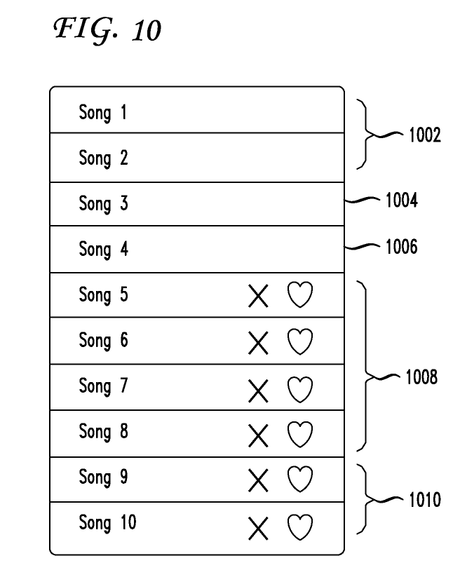

FIG. 10 illustrates the different portions of the playlist. Portion 1002 illustrates previously played songs. Selection 1004 illustrates the currently playing track. Selection 1006 illustrates the next track to be played. Portion 1008 illustrates user requested songs, and 1010 represents automatically added songs. Songs in the portions 1002, 1004, and 1006 cannot be voted on because their place in the queue is already established. Songs in portion 1002 have already been played, the song in 1004 is playing and the song in 1006 will play next. However, songs in portions 1008 and 1010 can be voted upon and thus they display the voting icons.

In addition to voting and adding songs, the present system can also include other features. For example, in some embodiments request limits can be established. To prevent one person from filling up the queue with requests, an optional limit should be configurable by the host. Also, an additional option could allow the host to choose whether or not songs can be re-requested after they have been played.

In some embodiments, remote guest users can add tracks from the community playlist to a wish list of songs to purchase later. This process would be similar to tagging a song playing on an HD Radio. When the portable device accesses an online store, a link from each tagged song would allow the user to purchase the song from an online store.

In some embodiments, banning a user can be useful. If a user hogs the queue, or requests undesirable songs, the host may wish to block the offending user out of the system. This would require requests in the system list to be identifiable by user. It would also require a user interface for banning the user, and managing the list of previously banned users.

In a similar fashion, in some embodiments the host can be a karaoke machine or other host operating in a karaoke mode. Users can pick songs and enter their names into the host operating as a kiosk. The host can play a requested music video on a monitor with lyrics for the currently playing song as is well known with respect to present day karaoke machines. Audience members could vote on the quality of the person's performance using their portable devices and the host can track and display the voting progress on the screen, for example, as an overlay it in the corner of the music video. If the performer received enough negative votes, then the performer can be voted off and their song ended. The host could also display the next performer in another corner of the secondary monitor.

In some embodiments, guests can share their own music storage on their portable device with the host device. To enhance the playlist, guests could be allowed to send tracks from their own library to the queue. This would allow music outside the host's library to be played. After a song is played, any trace of the streamed song anywhere but on the guest's device can disappear if not already owned by the host.

In commercial settings it could also help to promote a Jukebox pay-as-you-listen workflow, where guests may buy a song on-the-spot in order to hear it. Depending on the environment, either the guest or the host can retain the purchased song. In some embodiments a commercial interface is contemplated which will provide an interface for a monetary transaction in order to select a song from the host. This embodiment is similar to a Jukebox today where a user pays money to listen to songs. In this context the user can pay and select the songs to be played from their portable device.

In some embodiments guests can view a profile of a requester of a given song. The user could view other songs by that requester, add the guest as a friend in a social network, or tag songs from the guest's “favorites” list for later purchase.

In some embodiments the auto-queuing algorithm can select songs for queuing for every user's library to enhance the pool of listening choices. Additionally the auto-queuing algorithm can be coupled with a similarity algorithm or collaborative filter to select songs that are deemed similar to each other. Using a collaborative filter to access guest's libraries that are connected to the system can help automatically steer the music towards the tastes of the crowd.

Other features can be added such as a message board to accompany the playlist. Users could comment on the party in a live feed.

In some embodiments, a centralized host is not necessary. In such embodiments, a portable device can originate a playlist and other portable devices can join the playlist as if the portable device was the host. If the portable device acting as the host leaves the party, the other portable devices can continue to share the playlist. This embodiment can be especially useful in situations where the portable devices are not communication over a local area network, but directly, for example using the BLUETOOTH standard.

This embodiment can also be useful in a situation wherein a group of users end up together, for example, on an airplane, and desire to create a kind of ad hoc community playlist. Other portable devices can share the playlist with the originator, but part way through the flight, the originator might want to watch a movie and leaves the community. Others participating in the communal playlist can still interact with it without needing the originator device to host the playlist. This can be carried out in a number of ways. When the originator leaves the community, the media management program hosting the playlist can assign another device as the host. Alternatively no host device is needed. Each device can have a local store of the playlist in its RAM and the community of portable devices can update the other devices in the community using multicast communications or other communication method that shares information with multiple users. Each portable device can then update its own copy of the playlist. While sharing the playlist, it can also be necessary in this scenario to share media as well as described infra.

By way of example only, an exemplary use scenario will be discussed to make the operation of the system more clear. One example of a dynamically generated playlist is the PARTY SHUFFLE playlist or the ITUNES DJ playlist in the media management software ITUNES distributed by Apple Inc. of Cupertino, Calif., which provides a continuous mix of music. Songs can be added to ITUNES DJ automatically by ITUNES or manually by the user. The user can then reorder songs.

A source playlist option limits the available library of songs for Party Shuffle auto-selection. By default, ITUNES DJ selects randomly from the user's entire library. There is also an option to “Play higher rated songs more often”, which weights auto-selection by a song's star rating in ITUNES.

The user can specify the number of visible songs in the ITUNES DJ play history, and the number of upcoming songs that should be visible in the queue. A “Refresh” button, when pressed, replaces all auto-selected songs in the queue with a new semi-random set. Songs that were manually added to the queue by the user are left untouched.

When a user wants to view or control ITUNES DJ remotely using their portable device, the user instructs their device to find instances of ITUNES on the local network that have ITUNES DJ guest access turned on. When guest libraries are available, a selection is made available for joining that “party.” The ITUNES library name is displayed, along with the optional welcome message specified in ITUNES DJ settings, if available.

If a user selects a library that has a password set, the portable device prompts for a password using a single-line, text-input screen. If the password succeeds, it can be saved on the portable device to avoid having to enter the password in the future. If the prompted or saved password fails, a message will be presented to the user asking him/her to try again. If three consecutive password attempts are unsuccessful, the user is backed out to the Settings list.

Turning on guest access in ITUNES advertises a new BONJOUR network service, with type “._remote-jukebox._tcp”. When a user opens the settings menu on the portable device, it scans for services with this type on the network and presents each to the user. Each service is resolved immediately to collect more information about the server for display and connection.

The library name and welcome message are specified in the host-info. These two fill out the table cells that populate the library selection screen on the portable device. Selecting a library attempts to login to the host to fetch a session-id for further transactions. If the host-info specifies that the server requires a password to login, any stored passwords are first attempted for authentication by the portable device. If those fail, or none are available, a user-prompted password will be used and stored for future connections. Passwords are sent without encryption from the portable device to ITUNES, but in some embodiments they can be encrypted.

Once connected the user can vote to influence the order that songs are played. Songs are ordered by voting scores. The song with the highest net positive votes is first in the queue. If songs have the same score, then the time it was added is used to break the tie. The first song in the playlist is the first one played. The act of requesting a song automatically gives that song a +1 vote score—this represents the vote for the person who requested the song. People can vote only once for a song. Doing this will either increase or decrease the vote score and the songs are automatically reordered after a vote is cast. If a user requests a song that is already in the queue, this acts the same as giving the existing song a positive vote. Users are allowed to change their vote.

Another aspect of the disclosure involves a user being able to modify their vote score to be more or less than a +1 vote. For example, the system may store information about user votes such that if a user votes periodically and typically votes with the majority, they can gain more credibility in the system such that when they vote, their vote accounts for, for example, 1.2 or 1.5 votes. In this respect, users with more experience with this system can have their votes weighted more than standard votes. This can invoke an enjoyable competition amongst users to try to enhance their effect on the playlist outcome. Similarly, other users may vote rarely or may commonly vote for less desirable media items in relationship to others in their group and have their vote reduced to be less than the standard vote. In another aspect, users can enhance or decrease the effect of each vote by other mechanisms such as by paying a fee or performing some other function that allows them to increase the value of each individual vote.

This process can also work in the reverse, for example, if a user votes often or numerous times for the same media item in an attempt to unduly enhance its position in the playlist, the system can recognize these efforts and reduce the value or the per vote effect on the playlist order. Similarly, other mechanisms can be applied to affect somebody's vote. For example, a motion detection device within a mobile device may identify that the user is not only voting but perhaps using the mobile device while dancing, walking or in some other fashion that can be connected with the currently played music. In this respect, users can have their vote enhanced based on their participation with the songs that are being played. In other words, those that may have their devices while dancing can have their votes increased in effect which those sitting on the sidelines and not dancing, as would be indicated by the lack of motion associated with their mobile device, may have their votes adjusted accordingly.

Therefore, there are a variety of approaches which may be applied to vary and adjust the voting capabilities of individual users to further enhance the mechanisms disclosed herein for creating playlists and adjusting media items in particular playlists.

If all votes for a requested song are negative the song is removed from the list. Thus, a requested song can only be removed from the list if the person who requested it has changed their vote to a negative one. However, auto-selected songs can be voted up or down by any user. Thus, voting down an auto-selected song that has 0 votes automatically removes it from the list.

In some embodiments, the order of the playlist can be adjusted without explicit voting. As discussed above, using devices having motion detecting capability, the system can learn if party guests are dancing to a song that is currently playing. Based on this information the host can rearrange the playlist to promote similar songs in the playlist or queue songs that are similar in the playlist.

The playlist is divided into three parts: history, current song, and upcoming. The history lists songs that have already played in ITUNES DJ. The current song is the single active song in the playlist. The upcoming portion is divided into three parts: forced, voted, and shuffled. Forced songs appear immediately following the current song. Songs in this section can be reordered at the will of the host. Voted songs are grouped together and follow the forced songs in the playlist. Songs in this section cannot be manually reordered, though a song could be pulled out of the voted group and promoted to the forced list by the host. Shuffled songs are automatically added by ITUNES and can also be reordered manually or by voting. Songs in this section will always follow voted songs, unless manually moved up in the list to the forced section of upcoming songs. Thus in this example, portions of the list are vote-independent and other portions are vote-dependant.

Reordering can be done via ITUNES's standard user interface, or by using the user interface for the ITUNES DJ playlist on the portable device. If a guest requests a song that is already in the forced list, the vote is absorbed by the infinite power of the forced song, since it is already scheduled to play anyway.

To visually display the vote score of a song the ITUNES DJ playlist, ITUNES has a column to represent the vote score for each song. Each upcoming track is also presented with buttons to vote up and vote down each song. Unlike voting from the portable device, where each device can only register one vote per song, voting from the ITUNES user interface will register each vote uniquely and always increment the total number of votes. This allows kiosk-style operation of ITUNES, where guests without a portable device may still express their opinion by voting at the ITUNES host.

When a portable device successfully connects to ITUNES, it immediately presents a Now Playing screen when the ITUNES library is playing or paused. The Now Playing screen allows authorized paired portable devices to adjust player settings and transport controls: play, pause, skip forward or back, scrub the current song, adjust volume, and change speakers. A guest portable device, on the other hand, has no control over the player. It can only request and vote for songs. There is no transport, volume or routing control by guest portable devices.

Visually, transport controls can be replaced with a single button allowing the user to Request a Song. Pressing this button presents the user with a view of all songs in the library that are available to ITUNES DJ (limited by the source selection in ITUNES).

The ITUNES DJ playlist on the portable device can display each song with its artist, title, and album art. It can also display each song's voting score and number of votes, and can encourage the user to vote by presenting a control in each cell.

The voting control starts off displaying a neutral state, with both positive and negative vote options available. When the positive side of the control is selected, the user song is given a positive vote. Likewise, when negative side is selected, a negative vote is applied to the song. Each subsequent selection on the voting control toggles the vote from positive to negative and back.

When a vote is registered on the portable device, it can be immediately delivered to ITUNES to update the song ranking and ordering. To prevent song ordering from changing under the user while he/she is interacting with the list, ordering changes can be postponed until the interval since the last touch event has exceeded 2 seconds. After three seconds, the list can reorder, delete or insert tracks animated to their proper new locations in the list.

The current song can be displayed with highlighting so that it is distinguished from the rest of the list. Scrolling the list to see upcoming songs pins the table cell for the current song to the top of the list, leaving upcoming songs to scroll under it. Scrolling the list backwards to see history scrolls as otherwise expected, potentially pushing the current song off the bottom of the screen.

All users (guests and hosts) can be presented with a “Request a Song” button when viewing the ITUNES DJ playlist. This encourages the user to queue songs frequently, enhancing the ITUNES DJ experience.

Selecting the “Request a Song” button causes a drawer to be presented over the application. The selection of songs should be limited to the scope of the source playlist, set in ITUNES.

When a guest picks a song, the drawer is immediately closed. This prevents guests from adding more than one song at a time. When a host picks a song, the drawer remains open until a “Done” button is pressed. This gives additional convenience to the host, also making it easier to use ITUNES DJ for personal listening. When the drawer is closed, the list is automatically repositioned to center the newly selected song in the middle of the screen.

Tapping on a song in the ITUNES DJ list takes the user to a song details screen. The song detail screen presents the same set of information visible on the playlists. Instead of displaying the voting control, two explicit buttons expressing negative or positive preference, are presented below the song detail. Tapping one or the other sets the user's vote positive or negative.

Authorized users are also presented with two additional buttons, reading “Play Now” and “Play Next”. “Play Now” replaces the currently playing song with the one visible in the details screen. Selecting “Play Next” adds it to the queue following the currently playing song.

Also visible in the details list is a section recommending related songs to the user. Each song in the recommend list will have a ‘+’ accessory that, when clicked, will request the song in ITUNES DJ, and pop the view back to the list, displaying the newly added song.

While throughout the above description the technology has been described as pertaining to music, any media item can be used with this system. It is fully contemplated herein to be able to create and remotely manage lists containing any number of different media types such as, but not limited to, video, movies, still images, or any other file or combination of files that can be joined to a playlist. Accordingly, music as it is mentioned above should be considered as no more than an embodiment of the presently described system and method.

Embodiments within the scope of the present invention may also include tangible computer-readable media for carrying or having computer-executable instructions or data structures stored thereon. Such computer-readable media can be any available media that can be accessed by a general purpose or special purpose computer. By way of example, and not limitation, such tangible computer-readable media can comprise RAM, ROM, EEPROM, CD-ROM or other optical disk storage, magnetic disk storage or other magnetic storage devices, or any other medium which can be used to carry or store desired program code means in the form of computer-executable instructions or data structures. When information is transferred or provided over a network or another communications connection (either hardwired, wireless, or combination thereof) to a computer, the computer properly views the connection as a computer-readable medium or a non-tangible computer-readable medium in the wireless or signal per se context. Thus, any such connection is properly termed a computer-readable medium. Combinations of the above should also be included within the scope of the tangible or intangible computer-readable media. Tangible media excludes wireless interfaces or signals per se and must have a hardware component such as RAM, ROM, a hard drive, or other physical storage for the memory.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, objects, components, and data structures that perform particular tasks or implement particular abstract data types. Computer-executable instructions, associated data structures, and program modules represent examples of the program code means for executing steps of the methods disclosed herein. The particular sequence of such executable instructions or associated data structures represent examples of corresponding acts for implementing the functions described in such steps.

Those of skill in the art will appreciate that other embodiments of the invention may be practiced in network environments with many types of computer system configurations, including personal computers, hand-held devices, multi-processor systems, microprocessor-based or programmable consumer electronics, network PCs, minicomputers, mainframe computers, and the like. Embodiments may also be practiced in distributed environments where tasks are performed by local and remote processing devices that are linked (either by hardwired links, wireless links, or by a combination thereof) through a communications network. In a distributed environment, program modules may be located in both local and remote memory storage devices.

Communication at various stages of the described system can be performed through a local area network, a token ring network, the Internet, a corporate intranet, 802.11 series wireless signals, fiber-optic network, radio or microwave transmission, etc. Although the underlying communication technology may change, the fundamental principles described herein are still applicable.

The various embodiments described above are provided by way of illustration only and should not be construed to limit the invention. For example, the principles herein may be applied to an online store accessible wirelessly by a portable media playback device or by a personal computer physically connected to a network. Those skilled in the art will readily recognize various modifications and changes that may be made to the present invention without following the example embodiments and applications illustrated and described herein, and without departing from the true spirit and scope of the present disclosure.

We claim:

1. A method for facilitating community ranking of items in a playlist comprising:
transmitting information to a plurality of user devices, the information including metadata related to media items in a playlist which includes at least the order of the playlist, community ranking information, song title, and artist name;
receiving from at least one of the plurality of user devices a vote on a media item; and
organizing the playlist based on the received votes.

2. The method of claim 1, wherein the playlist includes a vote-independent region and a vote-dependent region and the step of organizing the playlist based on the received votes operates to organize the vote-dependent region of the playlist.

3. The method of claim 1, wherein the votes can be positive or negative votes.

4. The method of claim 1, wherein the step of receiving further includes receiving requests for a media item not in the playlist.

5. The method of claim 4, wherein a request for a media item not in the playlist constitutes a positive vote for that media item.

6. The method of claim 1, wherein media items in the playlist are automatically chosen and added to the playlist by a program on the playlist host device.

7. The method of claim 6, where the media items added to the playlist by a program on the playlist host device are added to the bottom of the playlist.

8. A processor-implemented method for facilitating community interaction with a playlist on a host device, the method comprising:
sending a playlist on a host device to a plurality of portable devices for display on a graphical user interface;
receiving from at least one portable device a positive or a negative vote for a media item in the playlist; and
adjusting a media item position in the playlist based on the received vote, wherein media items receiving positive votes are advanced and media items receiving negative votes are demoted in the playlist.

9. The processor-implemented method recited in claim 8, wherein the media item is removed from the playlist if the cumulative indications are negative.

10. The processor-implemented method recited in claim 8, wherein the portable devices connect to and communicate with the electronic device over a local area network.

11. The processor-implemented method recited in claim 8, wherein the electronic device is a jukebox.

12. The processor-implemented method recited in claim 8, wherein the electronic device is a personal computer.

13. The processor-implemented method recited in claim 8, wherein the playlist has at least one set portion which is not susceptible to adjusting the positions of the media items in this portion and at least one adjustable portion which is susceptible to adjusting the positions of the media items in this portion.

14. The processor-implemented method recited in claim 8, wherein the plurality of portable devices are substantially proximate to the host device such that users of the devices are at the same social gathering.

15. A processor-implemented method for remotely queuing media items on a host device by a plurality of users, the method comprising:
providing portable devices with information about a media library on a host device for display as user-selectable objects in a graphical user interface;
receiving from the portable devices requests to add items from the available media library to the playlist; and
adding the requested media items to the playlist.

16. The processor-implemented method for remotely queuing media items as recited in claim 15, wherein at least one of the portable devices is a guest device.

17. The processor-implemented method for remotely queuing media items as recited in claim 15, wherein the available media library is a subset of the host device's full library.

18. The processor-implemented method for remotely queuing media items as recited in claim 15, wherein the available media library is a combination available media library on the host device and the media library on the portable device used for queuing.

19. The processor-implemented method recited in claim 15, wherein the portable devices are substantially proximate to the host device such that users of the devices are at the same social gathering.

20. A tangible computer-readable medium having a computer-readable program code for facilitating community interaction with a playlist on a host device, the computer-readable medium comprising computer program code causing a host device to:
send information about a playlist on a host device to a plurality of portable devices for display on a graphical user interface;
receive, from at least one portable device, a positive or a negative vote for a media item in the playlist; and
adjust a media item position in the playlist based on the received vote, wherein media items receiving positive votes are advanced and media items receiving negative votes are demoted in the playlist.

21. The tangible computer-readable medium recited in claim 20, wherein the media item is removed from the playlist if the cumulative indications are negative.

22. The tangible computer-readable medium recited in claim 20, wherein the portable devices connect to and communicate with the electronic device over a local area network.

23. The tangible computer-readable medium recited in claim 20, wherein the host device is a jukebox.

24. The tangible computer-readable medium recited in claim 20, wherein the host device is a personal computer.

25. The tangible computer-readable medium recited in claim 20, wherein the playlist has at least one set portion which is not susceptible to adjusting the positions of the media items in the this portion and at least one adjustable portion which is susceptible to adjusting the positions of the media items in this portion.

26. The tangible computer-readable medium recited in claim 20, wherein the plurality of portable devices are substantially proximate to the host device such that users of the devices are at the same social gathering.

27. A tangible computer-readable medium having a computer-readable program code for remotely queuing media items on a host device by a plurality of users, the computer-readable medium comprising computer code causing a host device to:
provide portable devices with information about a media library on a host device for display as user-selectable objects in a graphical user interface;
receive from the portable devices requests to add items from the available media library to the playlist; and
add the requested media items to the playlist.

28. The tangible computer-readable medium for remotely queuing media items as recited in claim 27, wherein at least one of the portable devices is a guest device.

29. The tangible computer-readable medium for remotely queuing media items as recited in claim 27, wherein the available media library is a subset of the host device's full library.

30. The tangible computer-readable medium for remotely queuing media items as recited in claim 27, wherein the available media library is a combination available media library on the host device and the media library on the portable device used for queuing.

31. The tangible computer-readable medium recited in claim 27, wherein the portable devices are substantially proximate to the host device such that users of the devices are at the same social gathering.

32. A playlist host device for facilitating community interaction with a playlist, the device comprising:
a processor;
an electronic communications interface configured to control the processor to send information about a playlist on a host device to a plurality of portable devices for display on a graphical user interface and configured to receive from at least one portable device a positive or negative vote for a media item in the playlist; and
a module configured to control the processor to receive data from the electronic communications interface and in response to the data, adjusting playlist by promoting or demoting a media item in the playlist based on the received vote.

33. The device as recited in claim 32, wherein the plurality of portable devices connect to and communicate with the electronic device over a local area network.

34. The device as recited in claim 32, wherein the electronic device is a personal computer.

35. The device as recited in claim 32, wherein the plurality of portable devices are substantially proximate to the host device such that users of the devices are at the same social gathering.

36. A playlist host device for remotely queuing media items by a plurality of users, the host device comprising:
a processor;
a communications interface configured to provide portable devices with information about an available media library on a host device and further configured to receive from the portable devices requests to add items from the available media library to the playlist; and
a processor configured to receive data from the communications interface and in response to the data adding media items to the playlist corresponding to the requests from the portable devices.

37. The device as recited in claim 36, wherein at least one of the portable devices is a guest device.

38. The device as recited in claim 36, wherein the available media library is a subset of the host device's full library.

39. The device as recited in claim 36, wherein the available media library is a combination available media library on the host device and the media library on the portable device used for queuing.

40. The device as recited in claim 36, wherein the portable devices are substantially proximate to the host device such that users of the devices are at the same social gathering.
